(19) United States
(12) Patent Application Publication
(10) Pub. No.: US 2014/0064923 A1
(43) Pub. Date: Mar. 6, 2014

(54) SLURRY PUMP WITH ADJUSTABLE LINER

(71) Applicants: Martin E. Barnes, Glen Burnie, MD (US); Aaron S. Montgomery, New Richmond, WI (US); John V. DeNuto, Pasadena, MD (US)

(72) Inventors: Martin E. Barnes, Glen Burnie, MD (US); Aaron S. Montgomery, New Richmond, WI (US); John V. DeNuto, Pasadena, MD (US)

(73) Assignee: Ellicott Dredges, LLC, Baltimore, MD (US)

(21) Appl. No.: 13/596,098

(22) Filed: Aug. 28, 2012

(51) Int. Cl. F04D 29/42; B23P 6/00; F04D 7/04

(52) U.S. Cl. 415/118; 415/128; 29/888.021

(57) ABSTRACT

A pump comprising a housing, an impeller within the housing defining an axis, a front head connected to the housing, a liner disposed between the front head and the impeller, and at least one actuator operatively connected between the front head and the liner to move the liner axially with respect to the impeller, the actuator being adapted for connection to an actuation system.

### FIELD OF INVENTION

The present invention relates generally to a slurry pump, and, more particularly, to centrifugal slurry pump for dredging.

### BACKGROUND

Centrifugal pumps are commonplace in industry and are used in a variety of pumping applications. Referring to FIGS. 6a-6c, a typical centrifugal pump 600 is shown. The centrifugal pump 600 is integrated with a motor/gearbox 650, and has a housing 601. Referring to the cross section of the pump shown in FIG. 6c, the housing 601 contains an impeller 602 and is connected to a front head 603.

Of particular interest herein are pump applications involving slurries or other materials which tend to be abrasive to the pump. Such applications include, for example, dredging and mining in which soil/mud/sand in one location is mixed with water and pumped through a pipeline to a different location. In such applications, the pumps are fitted with protective liners, which are disposed between the pump impeller and the front head or cover of the pump. The pump 600 shown in FIG. 6c has front and back liners 604a, 604b, respectively. Liners are wearing components, which are intended to be replaced periodically.

The efficiency of a centrifugal slurry pump is dependent upon the gap 610 between the impeller and the front liner 104a. This gap is set typically at the factory. As the pump is operated this gap widens due to wear. The front liner typically wears about twice as fast as the back liner. The more abrasive the material is being pumped, the more rapidly the liner wears. As the gap becomes wider, the efficiency of the pump diminished as a result of the reduction in total dynamic head (TDH). Therefore, to maintain the efficiency of the pump, the front liner must be periodically adjusted with respect to the impeller to provide an optimum gap.

There are three popular methods to adjust the gap 610 in the slurry pump back to factory specifications. The first involves moving the bearing box of the pump. Specifically, the bolts that hold down the entire bearing block of the pump assembly are loosened and the bearing block is moved towards the front liner. Then the bolts are retightened. This method takes time and it is difficult to set the gap to original factory specification. Ordinarily, maintenance personnel must remove the suction clean-out cover and reach inside the pump cavity with a feeler gauge to check the gap. Another drawback of this approach is that moving the entire bearing block can cause axial mis-alignment that can result in bearing wear and/or overheating.

Another approach to adjust the gap between the liner and the impeller is to move the front liner toward the impeller. This is accomplished by adjusting inward jacking bolts 620 which are installed through the front head 603 as shown in FIG. 6c. As with the previous method described above, this method takes time and again makes it very difficult to set the gap to the original factory specification. Another negative with this approach is that the potential exists to adjust the gap unevenly which will result in uneven liner wear and premature liner replacement.

Yet another approach for adjusting the gap is to disassemble the wet end of the pump. This is the least desirable method, but necessary if the pump is not configured to be adjusted by moving the bearing housing or liner as described above. This method requires removing the suction clean-out cover, and measuring the impeller/front liner gap with feeler gauges. Once the gap is determined, the entire wet end of the pump, including the impeller, is removed. Next, copper gaskets are placed behind the impeller to narrow the gap to the desired measurement, and the pump is reassembled. This is a very time consuming procedure.

Applicant has determined that the time spent in adjusting the gap between the impeller and the liner is significant and detrimental to productivity. For example, in a typical mining application, the slurry pump might have to be adjusted every 40-50 hours. The adjustment itself might take about 20-30 minutes if the bearing or liner can be adjusted. (If the pump must be taken apart, as in the last approach described above, then the adjustment may take even longer.) In addition, emptying the pipeline, shutting down the dredge, raising the ladder and then restarting the dredge, lowering the ladder, and filling the pipeline to start dredging, takes an additional 30 minutes at a minimum. If such an operation typically has two 10-hour shifts (common), the pump must be adjusted two times a week. Therefore, in one year, these pump adjustments can account for more than 100 hours in lost production. Additionally, just before an adjustment is made, the pump tends to be particularly inefficient because the gap is relatively wide.

Therefore, Applicant has identified that liner pump adjustments have a significant impact on productively and that a need exists to minimize this impact. The present invention fulfills this need among others.

### SUMMARY OF INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention provides an approach for adjusting the gap between the liner and the impeller of a pump without dismantling, or even touching, the pump. Specifically, the approach relies on one or more actuators operatively connected between the front head and the liner to move the liner relative to the impeller. Not only does the use of the actuators facilitate quick adjustment of the gap, but also the actuation system to which the actuators are operatively connected provides feedback on the position of the actuators (and thus the position of liner relative to the impeller) such that the gap can be optimized for efficiency. Furthermore, in one embodiment, the actuation system is synergistically integrated with components of the machine to which the pump is connected such that few additional components are needed to control the actuators in the pump.

Accordingly, one aspect of the invention is a pump comprising a liner connected to at least one actuator to move the liner relative to the impeller. In one embodiment, the pump comprises: (a) a housing; (b) an impeller within the housing defining an axis; (c) a front head connected to the housing; (d) a liner disposed between the front head and the impeller; and (e) at least one actuator operatively connected between the front head and the liner to move the liner axially with respect to the impeller, the actuator being adapted for connection to an actuation system.

Another aspect of the invention is a method setting the gap between the liner and the impeller using the actuated pump described above. In one embodiment, the method comprises: (a) before starting the pump, actuating the actuator in a first direction such that the liner contacts the impeller; (b) actuating the actuator in a second direction a certain distance to a position to define a gap between the liner and the impeller; and (c) maintaining the actuator in the position.

### BRIEF DESCRIPTION OF DRAWINGS

FIG. 1 is cross sectional view of one embodiment of the pump of the present invention with actuators to move the liner axially in relation to the impeller.

FIG. 2 is a schematic of one embodiment of the actuation system of the present invention.

FIG. 3 is a schematic of another embodiment of the actuation system of the present invention.

FIG. 4 is a schematic of one embodiment of the actuation system of the present invention.

FIG. 5 is a cross section of another embodiment of the pump with the actuation system of the preset invention.

FIGS. 6a-6c depict a prior art centrifugal pump.

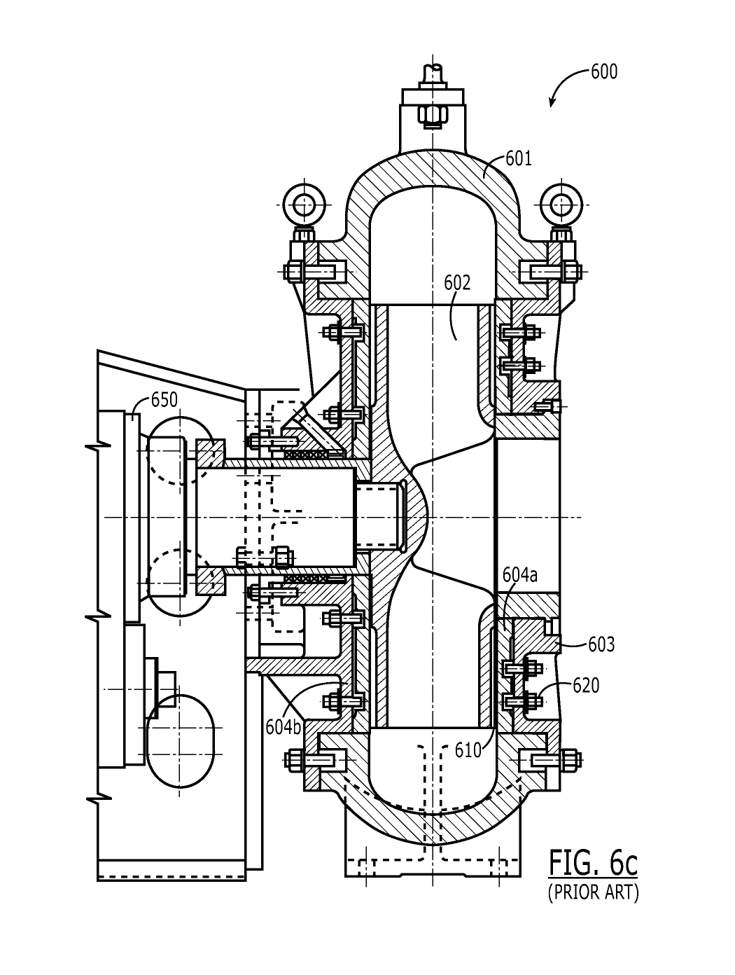

### DETAILED DESCRIPTION

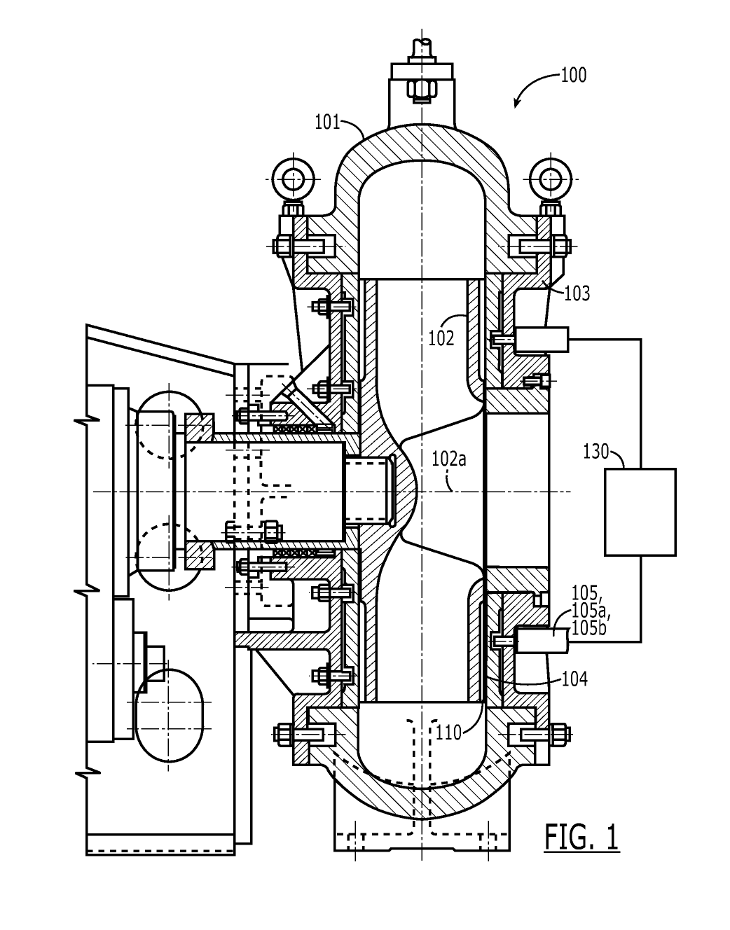

Referring to FIG. 1, a cross section of one embodiment of the pump 100 of the present invention is shown. The pump 100 comprises a housing 101, and within the housing 101 is an impeller 102 defining an axis 102a. A front head 103 is connected to the housing 100, and a liner 104 is disposed between the front head 103 and the impeller 102. The front head and impeller define a gap 110 therebetween. The pump also comprises at least one actuator 105 operatively connected between the front head 103 and the liner 104 to move the liner 104 axially with respect to the impeller 102 so as to adjust the size of the gap. Operatively connected to the actuator is an actuation system 130 for actuating the actuator and controlling the distance the actuator moves, thereby adjusting the gap size. These elements are considered below in more detail and with respect to selected alternative embodiments.

Generally speaking the housing 101, impeller 102, front head 103 and liner 104 are essentially standard components, which have well known configurations and functions. The front liner 104 in the pump 100, however, is modified slightly. Instead of attaching the liner with bolts, it is attached via a plurality (for example, three or four) of actuators 105. In the embodiment, shown in FIG. 1, four actuators 105 are located 90 degrees apart along the perimeter of the cover 103 as shown, although, in another embodiment, three actuators are located 120 degrees apart.

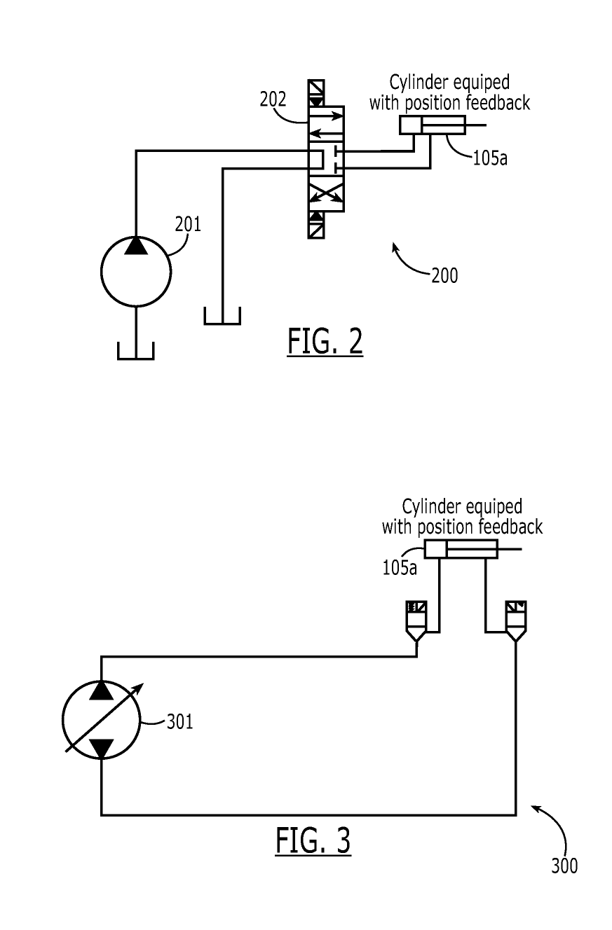

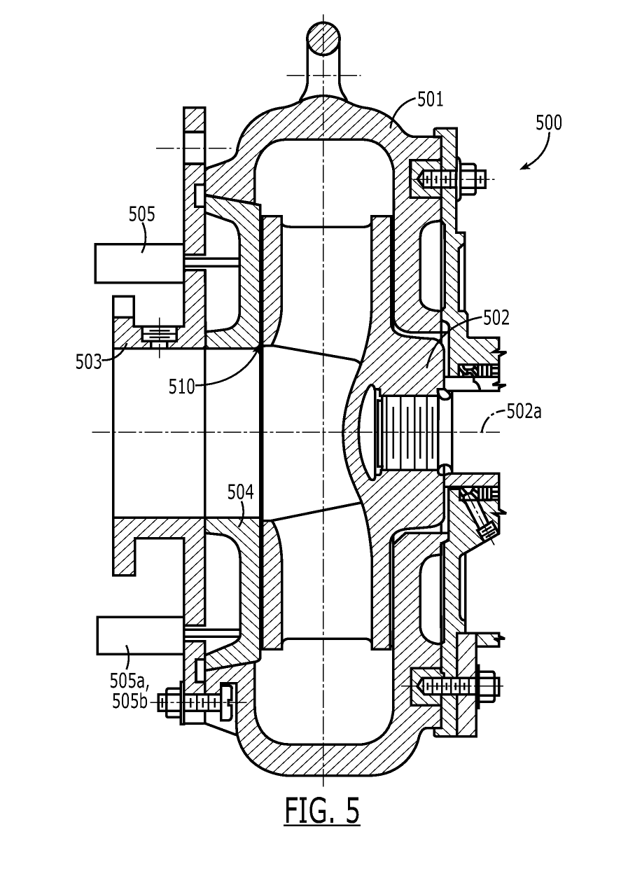

The actuators 105 may be any known mechanism for translating force (e.g. hydraulic, pneumatic, or torsional force) into lateral movement. Such mechanisms include, for example, a hydraulic piston 105a (see FIG. 2), a screw mechanism 105b (see FIG. 4), a pneumatic piston, and a rack-and-pinion mechanism, just to name a few. The actuator is adapted to interface with an actuation system. The actuation system 130 comprises a power source to provide force to the actuator such as a pump or motor, and a controller that is operated by the user or a computer. In one embodiment, the actuation system comprises a feedback mechanism, such as an encoder or transducer, to provide an indication of the actuator's position.

The actuation system may have a variety of configurations. For example, referring to FIG. 2, a hydraulic actuation system 200 for an actuator 105 in the form of a hydraulic piston 105a is shown. This particular embodiment utilizes an existing hydraulic pump 201 of the machinery to which the pump is connected, such as a dredging or mining rig. Although sharing the existing hydraulic pump is preferred from a cost and simplicity standpoint, it should be understood that the system 200 may have its own dedicated pump. The system 200 also comprises a multi-section valve 202 operatively connected to the hydraulic pump 201. In one embodiment, each section of the valve 202 is dedicated to a particular actuator. In this embodiment, each section comprises a two-way, three-position, open-center, pilot-operated, solenoid-controlled, spring-centered, variable-flow control valve. In one embodiment, once the system 200 moves the hydraulic pistons 105a such that gap between the liner and the impeller is optimized (discussed below), a proportional integral derivative (PID) loop maintains this position utilizing the feedback from a linear variable differential transformer (LVDT). In another embodiment, if a programmable controller is not available or does not have the capacity to run a PID loop as mentioned above, the gap may be maintained by the actuators while the hydraulic pump 201 is running by means of a non-back-drivable gear (e.g., a worm gear) or similar mechanism.

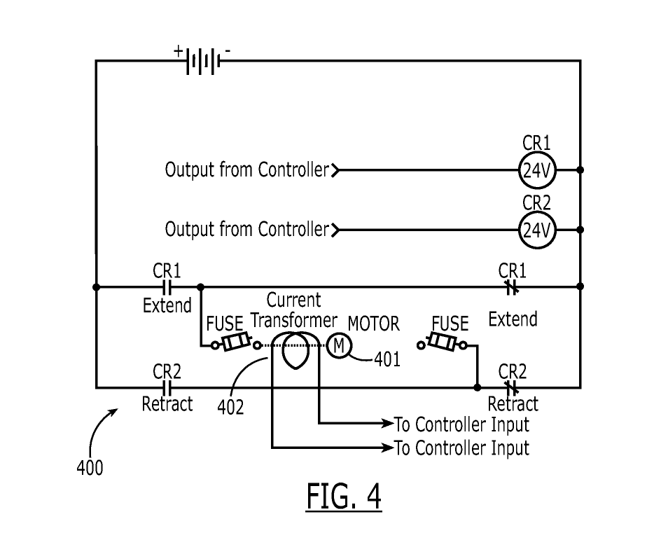

Referring to FIG. 3, another embodiment of the actuation system 300 is shown for operating the same hydraulic piston 105a. This embodiment differs from the embodiment of FIG. 2 in that it utilizes a bidirectional pump 301. This eliminates the need for a control valve, but requires the addition of a pump for each actuator in the embodiment shown. The embodiment also comprises poppet valves 302 disposed as close as possible to the cylinder 105a. These poppet valves are configured to close after the adjustment cycle is complete to stop all flow, thereby locking the cylinder in place until the next adjustment cycle is run.

Referring to FIG. 4, yet another embodiment of an actuation system 400 is shown. This embodiment is an electronic system, utilizing a stepper motor 401, a current transformer 402 to power the stepper motor 401, and a worm screw 105b (in place of the hydraulic piston 105a), which is rotated by the stepper motor. The current transformer 402 may be monitored for a sudden current rise as an indication that the worm screw 105b is pushing the liner against the impeller or has otherwise reached the end of its travel. From this position, the stepper motor can back up the worm screw a set number of pulses to set the gap. Each pulse to the motor will produce a movement of a known distance on the front liner. Once this distance is set, the motor powers down and the plate is held in place by the worm screw 105b.

The pump and acturation system combine to provide a simple and efficient approach for adjusting the gap between the liner and the impeller. In one embodiment, the pump and actuation system function to set the gap by actuating the actuator until the liner contacts the impeller. To avoid damage to the liner and impeller, this step should be conducted while the pump is idle. An indication that the liner is contacting the impeller can be provided in different ways. In one embodiment, the indication is provided by noting the change in force required to advance the actuator. This change may be noted, for example, by a sudden increase in current draw by the motor as described above, or by an increase in hydraulic pressure.

After the liner is in contact with the impeller the controller backs up each actuator the distance necessary to establish the optimum gap. Backing the actuator up a certain distance can be achieved in different ways. For example, in one embodiment, the controller notes the position of the actuator when the liner is in contact with the impeller, and then backs the actuator to a different predetermined position. Alternatively, the controller may be programmed to calculate the distance the actuator moves for a given period it is actuated. Still other approaches for setting the gap with the actuator will be known by others in light of this disclosure.

Gap adjustment can be accomplished at various times. For example, in one embodiment, the gap is adjusted by the user before dredging. For example, after starting the dredge, but prior to dredging, the operator presses a button on a control panel or joy stick. The pump is automatically adjusted to the factory setting in seconds using the process described above. In another embodiment, if the dredge is equipped with a PLC (Programmable Logic Control) the pump adjustment can be programmed to be performed as part of the normal dredge start-up sequence.

In another embodiment, the gap between the impeller and liner is adjusted dynamically by monitoring the efficiency of the pump. Specifically, in one embodiment, the power to the pump is monitored along with the pump's output. A PLC is used to continuously optimize the gap to maximize the pump's efficiency. Still other approaches for adjusting the gap between the liner and the impeller will be obvious in light of this disclose.

In yet another embodiment, the gap is adjusted using a measuring device to measure the distance between the liner and the impeller. Suitable measuring devices include, for example, lasers, acoustical, infrared, etc. Such an approach may be performed while the pump is operating or when it is idle. For example, in one embodiment, a bore hole is added to front head 103 and the front liner, thereby providing an “eye” into the pump itself. A laser measurement device is disposed on the back of the head such that it is pointed through the borehole. Once calibrated, the laser is used to measure the gap between the impeller and the liner. Although the measurement may be taken while the pump is in operation, preferably it is taken when only water is being pumped and not material which can interfere with the laser beam. To keep the measurement device from being worn or destroyed by the abrasive material, another borehole may be added diagonally through the head and connect to the bore hole through which the measurement device is pointed. An air compressor would pump air into this cavity with enough positive pressure to keep water/debris from entering.

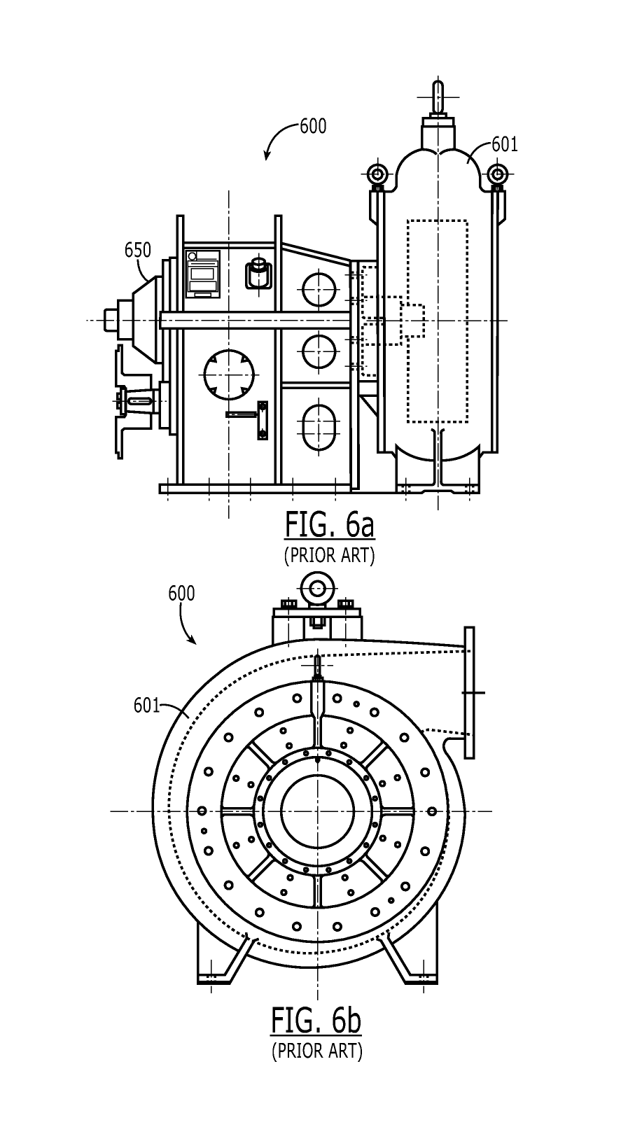

It should be understood the pump 100 shown in FIG. 1 is just one embodiment of the invention and other configurations of liners may be adjusted with the actuators of the present invention. For example, referring to FIG. 5, a cross section of another embodiment of the pump 500 of the present invention is shown. The pump 500 comprises a housing 501, and within the housing 501 is an impeller 502 defining an axis 502a. A front head 503 is connected to the housing 500, and a liner 504 is disposed between the front head 503 and the impeller 502. In this embodiment, just a forward liner is shown. The front head and impeller define a gap 510 therebetween. The pump also comprises at least one actuator 505 operatively connected between the front head 503 and the liner 504 to move the liner 504 axially with respect to the impeller 502 to adjust the size of the gap. Operatively connected to the actuator is an actuation system 530 for actuating the actuator and controlling the distance the actuator moves, thereby adjusting the gap size.

It should be understood that the foregoing is illustrative and not limiting and that obvious modifications may be made by those skilled in the art without departing from the spirit of the invention. Accordingly, the specification is intended to cover such alternatives, modifications, and equivalence as may be included within the spirit and scope of the invention as defined in the following claims.

What is claimed is:

1. A pump comprising:
a housing;
an impeller within said housing defining an axis;
a front head connected to said housing;
a liner disposed between said front head and said impeller; and
at least one actuator operatively connected between said front head and said liner to move said liner axially with respect to said impeller, said actuator being adapted for connection to an actuation system.

2. The pump of claim 1 wherein said actuator comprises a position indicator to provide an indication of the position of said actuator.

3. The pump of claim 2, wherein said position indicator is an encoder.

4. The pump of claim 1, wherein said actuator is a hydraulic piston.

5. The pump of claim 4, wherein said actuation system comprises a hydraulic motor.

6. The pump of claim 5, wherein said actuation system comprises a programmable logic controller.

7. The pump of claim 6, wherein said actuation system is part of a machine to which said pump is connected.

8. The pump of claim 7, wherein said machine is a dredge.

9. The pump of claim 1, wherein said actuator is a worm screw.

10. The pump of claim 9, wherein said actuation system comprises a stepper motor.

11. The pump of claim 1, further comprising said actuation system.

12. The pump of claim 11, wherein said actuation system is part of a machine to which said pump is integral.

13. A method of adjusting a gap between an impeller and a liner of a pump, said pump comprising a housing, the impeller within said housing defining an axis, a front head connected to said housing, the liner disposed between said front head and said impeller, and at least one actuator operatively connected between said front head and said liner to move said liner axially with respect to said impeller, said actuator connected to an actuation system, said method comprising:
(a) before starting said pump, actuating said actuator in a first direction such that said liner contacts said impeller;
(b) actuating said actuator in a second direction a certain distance to a position to define a gap between said liner and said impeller; and
(c) maintaining said actuator in said position.

14. The method of claim 13, wherein, in step (a), said actuator is actuated until a nonlinear increase in force is required to move said actuator.

15. The method of claim 13, wherein, in step (b), said actuation system moves said actuator to a certain position as a function of time.

16. The method of claim 13, wherein, in step (b), said actuation system moves said actuator to a certain position as determined by an encoder measuring the position of said encoder.

17. The method of claim 13, wherein the force to move said actuator is provided by a machine to which said pump is integrated.

18. The method of claim 17, wherein said force is hydraulic force.

19. The method of claim 17, wherein said force is electrical current.
